(19) United States
(12) Patent Application Publication
(10) Pub. No.: US 2021/0241941 A1
(43) Pub. Date: Aug. 5, 2021

(54) COMMUNICATION CABLES

(71) Applicant: Hewlett-Packard Development Company, L.P., Spring, TX (US)

(72) Inventors: Matthew G Lopez, San Diego, CA (US); Brian R Jung, San Diego, CA (US); Mary Lutz, San Diego, CA (US)

(73) Assignee: Hewlett-Packard Development Company, L.P., Spring, TX (US)

(21) Appl. No.: 17/049,081

(22) PCT Filed: Aug. 9, 2018
(86) PCT No.: PCT/US2018/046122

§ 371 Date: Oct. 20, 2020

(51) Int. Cl. H01B 7/40; H01B 3/50; H01B 7/18

(52) U.S. Cl. CPC H01B 7/40; H01B 7/18; H01B 3/50

(57) ABSTRACT

In an example, a communication cable may include a first conductive cable wrapped in a fabric sheath, and a second conductive cable, also wrapped in a conductive sheath. Further, the communication cable may also include a breakable adhesive bonding the fabric sheath of the first conductive cable to the fabric sheath of the second conductive cable.

### BACKGROUND

Electronic devices may be connected to and communicate with other devices such as accessories or other electronic devices using communication cables. A communication cable may engage with a communication port on each of the devices to be connected in order to facilitate the transmission of communication signals between such devices. In some situations, multiple communication cables may be employed to connect an electronic device to multiple different devices, and/or to facilitate the transmission of different types of signals.

### BRIEF DESCRIPTION OF THE DRAWINGS

FIG. 1 is a perspective view of an example communication cable.

FIG. 2 is a perspective view of an example communication cable.

FIG. 3A is a perspective view of an example communication cable.

FIG. 3B is a detail perspective view of an example communication cable.

FIG. 4 is a perspective view of an example communication cable.

FIG. 5 is a flowchart depicting an example method for fabricating a communication cable.

FIG. 6 is a flowchart depicting an example method for fabricating a communication cable.

### DETAILED DESCRIPTION

Electronic devices may be connected to and communicate with other devices such as accessories, sensors, peripheral devices, display devices, or other electronic devices using communication cables. A communication cable may be able to take signals, e.g., data, power, or other communication signals, from a first electronic device and transmit such signals along the length of the communication cable to another device, where such signals are received. In order to achieve this, a communication cable may engage with a communication port on each of the devices to be connected to facilitate such transmission of communication signals between such devices. In some situations, multiple communication cables may be employed to connect an electronic device to multiple different devices, and/or to facilitate the transmission of different types of signals between devices. In such situations, the multiple communication cables may have a tendency to become tangled with one another, and otherwise have a messy and disorganized appearance. As such, in some situations, it may be desirable to bundle multiple communication cables together to form an integrated wiring harness or cable bundle. Such bundling of the communication cables can provide a cleaner, more organized appearance and setup, as well as make it easier for the multiple communication cables to be routed in between devices.

In some situations, bundling of communication cables can be achieved by using traditional twist ties, elastic bands, rubber or polymer umbilical tubes, electrical tape, or other simple methods. Such methods of bundling, however, may make it difficult to route multiple cables to different locations, e.g., to different communication ports or different devices, since the communication cables may need to be different lengths. In other words, it may not be easy to split one communication cable away from the bundle of cables, and may result in having to use additional ties, tape, elastics, or other methods to maintain the remaining cables in the bundle. Additionally, such sporadic and repeated use of such simple bundling methods may have a messy and disorganized appearance.

Other methods of bundling communication cables together may include providing polymer cable sheaths or jackets that are bonded, at least partially, to one another such that each cable can be pulled from the other to a desired length. While maintaining a clean appearance for the bundle of communication cables, this technique is limited in use to cables that have a polymer sheath or jacket that can be co-molded with the polymer sheath of another cable to achieve the desired bonding. Such polymer sheath cables can often have the appearance of being cheap or low-quality. In some situations, however, it may be desirable to utilize a fabric-woven communication cable, or a cable having a fabric sheath, for a higher-end and quality appearance. Such fabric-woven communication cables cannot be co-molded with the sheath or jacket of other cables, and thus cannot obtain the traditional bonded-sheath structure. Additionally, such fabric-woven cables often cannot be simply glued or adhered to one another, as when pulling the cables apart to desired lengths may cause the fabric to tear, unwind, or otherwise may be damaging to the cable sheath. Further, employing a higher-end cable such as a fabric-woven cable may mean that it may be desirable to avoid a messy, damaged, and/or unprofessional appearance, such as may occur when bundling cables with ties, tape, or elastic bands, or when gluing cables together.

Accordingly, implementations, of the present disclosure provide communication cables that have a higher-end appearance and quality with a fabric-woven sheath or jacket. Further, communication cables according to implementations of the present disclosure can have multiple conductive cables, each having a fabric sheath, which can be bonded to one another while maintaining the integrity, and the higher-end appearance and quality, of the fabric sheaths. Thus, communication cables described herein can comprise a bundle of multiple communication cables that maintain a high-quality, clean and organized appearance, while enable single cables from the bundle to split from the bundle at desired lengths. Yet further, methods of fabricating such communication cables in accordance with the present disclosure are disclosed herein.

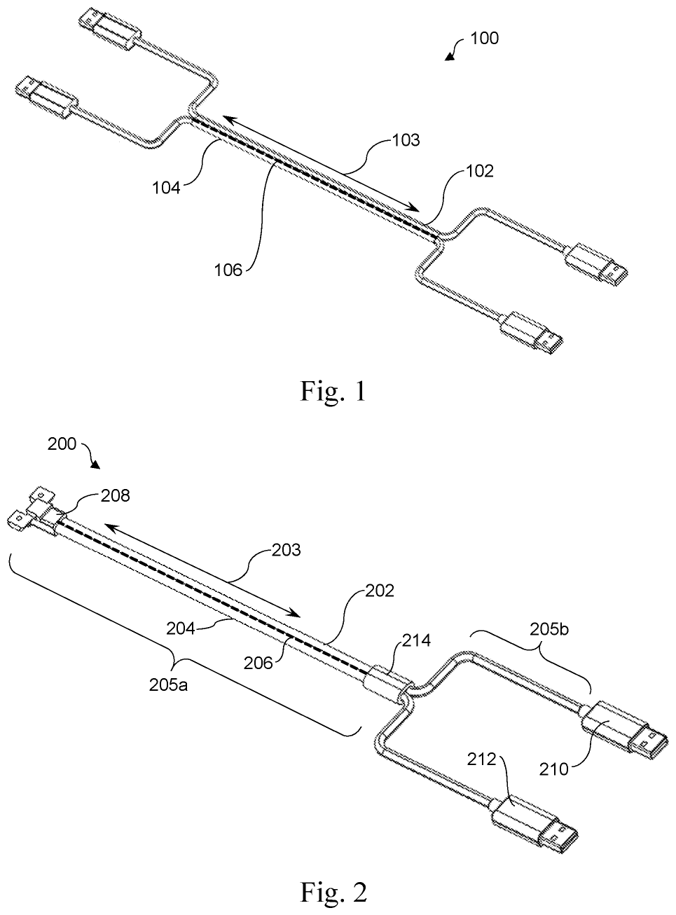

Referring now to FIG. 1, a perspective view of an example communication cable 100 is illustrated. Communication cable 100 may include a first conductive cable 102 wrapped in a fabric sheath, and a second conductive cable 104, also wrapped in a fabric sheath. Further, communication cable 100 may also include a breakable adhesive 106 bonding the fabric sheath of the first conductive cable 102 to the fabric sheath of the second conductive cable 104. The breakable adhesive 106 is illustrated as a broken line disposed in between the first conductive cable 102 and the second conductive cable 104. While described as a singular communication cable, communication cable 100 may be or may otherwise be described as a bundle of multiple communication cables, attached to one another with the breakable adhesive, and individually referred to as a conductive cable, e.g., first and second conductive cables 102, 104. For simplicity, only the first and second conductive cables 102, 104 are illustrated herein, but it is contemplated that the communication cable 100 could include more than two conductive cables bonded and bundled to one another using the breakable adhesive.

Each of the first and second conductive cables 102, 104 may be or may include a conductive element or arrays, braids, or groups of conductive elements capable, separately or together, of transmitting an electrical, optical, power, or other communication signal, or multiple signals or types of signals, along the length of the conductive cable 102, 104. In some implementations, either or both of the first and second conductive cables 102, 104 may have additional conductive elements and/or insulator elements to separate conductive elements from one another. Each of the first and second conductive cables 102, 104 may be capable of transmitting analog signals and/or digital signals. Further, in some implementations, each of the first and second conductive cables, 102, 104 may have a connector on each end of a length of the conductive cable. Such connectors may be able to mechanically and electrically, optically, or otherwise operably, engage the respective conductive cable with an electronic device, or a communication port thereon. In some implementations, the first and second conductive cables 102, 104 may each be a copper cable, an optical cable, a coaxial cable, a Universal Serial Bus (USB) cable, a power cable, or another type of conductive cable able to transmit signals.

Each of the first and second conductive cables 102, 104 may have a fabric sheath. That is, each of the conductive cables may have a protective sheath, jacket, or other outer covering which may protect and insulate, either electrically, thermally, or both, the conductive element or elements disposed within the protective sheath. Such protective sheath may be constructed of, or may include, at least in part, a fabric, a fabric weave, or another soft material.

The first and second conductive cables 102, 104 may be attached, bonded, or bundled to one another through the use of the breakable adhesive 106. The breakable adhesive 106 may be disposed along a length of the first conductive cable 102 and the second conductive cable 104, illustrated by example arrow 103. Such a length of adhesive may sometimes be referred to as a bonded length 103 of the communication cable 100 or the conductive cables thereof. In some implementations, the breakable adhesive 106 may be disposed along the length 103 such that the connectors of each of the first and second conductive cables 102, 104 are free from one another, and can be plugged in and engaged with separate mating or complementary connectors or ports of electronic devices. In other words, the breakable adhesive 106 may only be disposed along the portion or portions of the first and second conductive cables 102, 104 for which it may be desirable to keep tidy, neat, and professional looking, while the function and use of the connectors of such conductive cables is not inhibited by the breakable adhesive 106.

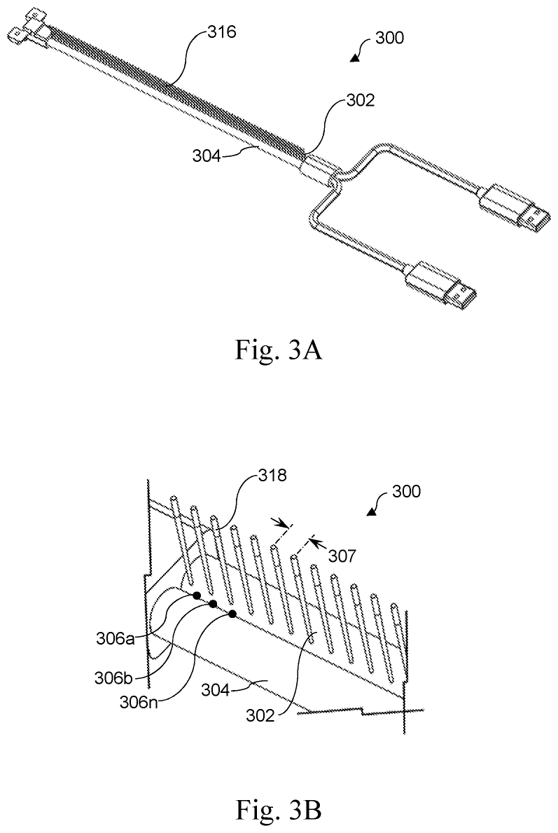

The breakable adhesive 106 may be applied along the length 103 of the first and second conductive cables 102, 104 as a series or array of discrete droplets. In other words, the breakable adhesive 106 may include an array of adhesive drops disposed along the length 103 of the first conductive cable 102 and the second conductive cable 104. Such a spaced disposition of the adhesive in drop formation allows, upon a sufficient pulling or splitting force being applied, a single drop of adhesive to break apart at a time. In other words, each drop of adhesive may be separately breakable from the other adhesive drops of the array of adhesive drops. In this context, splitting or pulling force may refer to a pulling force or tension a user or another mechanism may apply to a drop of adhesive, sometimes by way of pulling apart the free ends of the first and second conductive cables 102, 104. In some implementations, to ensure that it is easy enough for a user to break the adhesive, each drop of adhesive may break apart upon a pulling or splitting force of about 0.2 Newtons (N) to about 0.5 N being applied to the drop of adhesive. In other words, a splitting force of between about 0.2 N and 0.5 N, when applied across a cross-sectional area of a given drop of adhesive, may provide enough stress through the drop of adhesive to exceed the tensile strength of the drop, and break apart the drop of adhesive. Stated, differently, the breakable adhesive may break upon a splitting force of about 0.2 N to 0.5 N being applied between the first conductive cable 102 and the second conductive cable 104. Such a splitting force may be applied to the conductive cables, and thus the breakable adhesive, or a drop thereof, in the form of tension. Moreover, such a splitting force, while being sufficient enough to break the adhesive, may be insufficient to tear, unweave, or otherwise damage the fabric sheath of either conductive cable. Thus, a clean, tidy, and professional appearance of the communication cable 100 is maintained, even after splitting the conductive cables apart. The drops of adhesive are further described below with reference to FIGS. 3A and 3B.

The breakability of the individual drops of the breakable adhesive 106 may enable the bonded length 103 of the first and second conductive cables 102, 104 to be adjusted or shortened as needed for a given application of the communication cable 100. The length 103 of the bonded portions of the first and second conductive cables 102, 104 may be adjusted, or shortened, by a user or other mechanism pulling on a free end of either or both of the first and second conductive cables 102, 104. In other words, a user may pull the first and second conductive cables 102, 104 apart from one another until the necessary splitting force in tension is achieved to break a drop of adhesive. The pulling or splitting force may continue to be applied in order to break a desired number of drops of adhesive in order to achieve the desired bonded length 103 of the first and second conductive cables 102, 104.

Referring now to FIG. 2, a perspective view of an example communication cable 200 is illustrated. Example communication cable 200 may be similar to example communication cable 100, described above. Further, the similarly-named elements of example communication cable 200 may be similar in function and/or structure to the respective elements of example communication cable 100, as they are described above. The communication cable 200 may include a first conductive cable 202 and a second conductive cable 204. Each of the first and second conductive cables, 202, 204 may be wrapped in a fabric sheath, each fabric sheath extending along the length of, or a portion thereof, the first and second conductive cables 202, 204. The communication cable 200 may also include a breakable adhesive 206 disposed along a bonded length 203 of the communication cable 200, the breakable adhesive bonding the fabric sheath of the first conductive cable 202 to the fabric sheath of the second conductive cable 204.

The first and second conductive cables 202 may each have a first end and a second end, opposite the first end. In some implementations, the communication cable 200 may have a combined connector 208 communicatively and mechanically engaged with the first ends of the first and second conductive cables 202, 204. Additionally, the communication cable 200 may have a first separate connector 210 communicatively and mechanically engaged with the second end of the first conductive cable 202, as well as a second separate connector 212 communicatively and mechanically engaged with the second end of the second conductive cable 204. Thus, in some implementations, the communication cable 200 may be able to engage a single communication port of an electronic device with multiple other communication ports, sometimes on separate electronic devices. Each of the combined connector 208, and the first and second separate connectors 210, 212, may be able to mechanically and electrically, optically, or otherwise operably, engage the respective conductive cable with an electronic device, or a communication port thereon. The breakable adhesive 206 may include an array of adhesive drops disposed along the bonded length 203 in between the combined connector 208 and the first and second separate connectors 210, 212.

As described above, the array of adhesive drops of the breakable adhesive 206 may enable the communication cable 200 to be split apart such that each of the first and second conductive cables 202, 204 may have a desired length and engage with a separate communication port. This means that the communication cable 200 may have a bundled portion 205a, wherein conductive cables are still bundled together, and a free portion 205b. The free portion 205b may be free of adhesive altogether or may have adhesive that has previously been broken. In some implementations, the communication cable 200 may further include a strain relief 214, which may be movable along a length of the first and second conductive cables 202, 204. The strain relief 214 may be have a hollow, tubular, ring or collar-shaped construction, or another structure that enables the strain relief to surround the conductive cables and be moved along the length of the conductive cables. In some implementations, the strain relief 214 may separate the bundled portion 205a from the free portion 205b, such that forces exerted or pulled on the free portion 205b may not be transferred to intact adhesive drops of the bundled portion 205a. In further implementations, the strain relief 214 may be movable so as to effectively re-bundle portions of the conductive cables in the free portion 205b. In other words, after some of the breakable adhesive drops are broken, it may sometimes be desirable to re-adjust, e.g., shorten, the length of the free portion 205b of the communication cable 200. This can be accomplished by sliding the strain relief 214 along the length of the conductive cables to achieve the desired length of the free portion 205b, and inherently changing the length of the bundled portion 205a, as well. Therefore, in some implementations, the bundled portion 205a may not be the same length as the bonded length 203.

Referring now to FIG. 3A, a perspective view of an example communication cable 300 is illustrated. Example communication cable 300 may be similar to other example communication cables described above. Further, the similarly-named elements of example communication cable 300 may be similar in function and/or structure to the respective elements of other example communication cables, as they are described above. Communication cable 300 may include a first conductive cable 302 and a second conductive cable 304. Each of the first and second conductive cables, 302, 304 may be wrapped in a fabric sheath, each fabric sheath extending along the length of, or a portion thereof, the first and second conductive cables 302, 304. The communication cable 200 may also include a breakable adhesive disposed along a bonded length of the communication cable 300, the breakable adhesive bonding the fabric sheath of the first conductive cable 302 to the fabric sheath of the second conductive cable 304. FIG. 3A also illustrates an array 316 of application pins which are used to apply the breakable adhesive to the communication cable 300. Referring additionally to FIG. 3B, a detail perspective view of the example communication cable 300 is illustrated, including a portion of the array 316 of application pins. The array 316 may include a plurality of individual application pins 318, each application pin 318 to apply a drop of adhesive 306a, 306b . . . 306n, collectively referred to as breakable adhesive drops 306, to the fabric sheaths of the first and second conductive cables 302, 304, in order to bond the conductive cables to one another.

In some implementations, the application pins 318, and thus the breakable adhesive drops 306, may have a spacing 307 such that each breakable adhesive drop 306 is a discrete droplet of adhesive and not contacting neighboring drops. In some implementations, the spacing 307 may be about 3 millimeters (mm) between adjacent breakable adhesive drops 306. In further implementations, each drop of the breakable adhesive drops 306 may have a mass of about 0.02 grams (g) to 0.04 g. Such spacing of the drops of adhesive and such mass of the drops of adhesive may result in each drop of the breakable adhesive drops 306 having a splitting force of about between 0.2 N and 0.5 N. Such splitting force may be sufficient to break each drop of the breakable adhesive drops 306 yet may be insufficient to tear or otherwise damage the fabric weave or fabric material of the fabric sheaths of the first and second conductive cables 302, 304. In some implementations, the breakable adhesive may have a sufficient viscosity so as to enable a permeation of each drop of the breakable adhesive drops 306 into the fabric sheath of each of the first and second conductive cables 302, 304 of about 20% or less. Such a permeation of each adhesive drop into the fabric sheath enables sufficient adhesion between the fabric sheaths, while avoiding damage from occurring upon the drops of breakable adhesive splitting apart due to a splitting force being applied. In some implementations, the breakable adhesive is adhesive type LC-1113 from Minnesota Mining and Manufacturing Company (3M). In other implementations, other specific adhesives having a suitable viscosity may be used.

In some implementations, after the array of applications pins 318 applies the breakable adhesive drops 306 to the communication cable, the adhesive drops may be cured. In some implementations, curing may be carried out by the application of heat and/or light, a curing agent, or another curing method. In further implementations, the adhesive may be cured through the application of ultraviolet (UV) light.

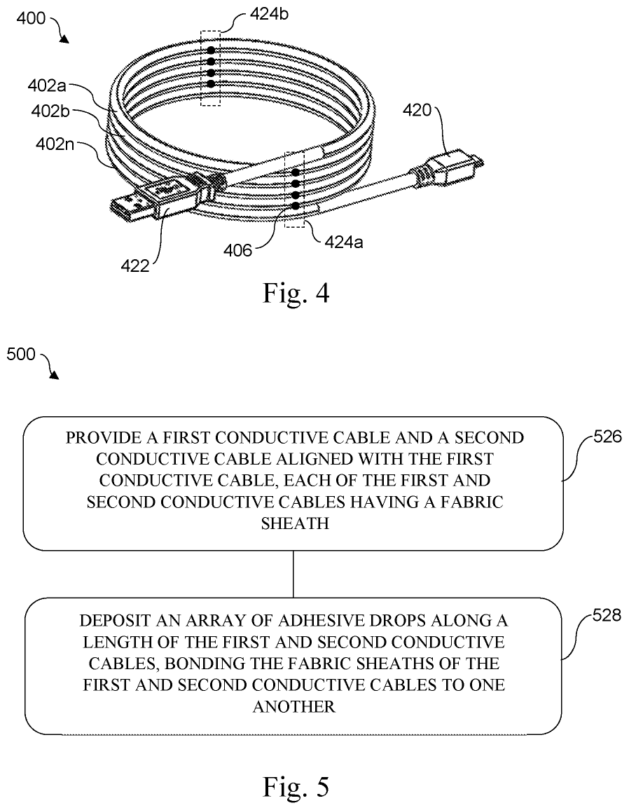

Referring now to FIG. 4, a perspective view of an example communication cable 400 is illustrated. Example communication cable 400 may be similar to other example communication cables described above. Further, the similarly-named elements of example communication cable 400 may be similar in function and/or structure to the respective elements of other example communication cables, as they are described above. Communication cable 400 may have a first connector 420 disposed at a first end of the cable, and a second connector 422 disposed at a second end of the cable, with a fabric sheath or weave covering the communication cable 400 in between the connectors. In some implementations, the communication cable 400 may be coiled as if in a storage or shipping orientation. In such an orientation, the communication cable 400 may have multiple conductive cable layers 402a, 402b . . . 402n, referred to collectively as conductive cables 402, depending on the length of the communication cable 400 and the size of the coils. The different conductive cables 402 may have a relationship to one another that may be analogous to the relationship to the first and second conductive cables as described above, in that the conductive cables 402 may be wrapped in a fabric weave or fabric sheath, and each conductive cable layer may be bonded to an adjacent conductive cable layer by breakable adhesive drops 406.

In some implementations the communication cable 400 may have a fabric sheath extending along substantially the entire length of the cable, and the breakable adhesive drops 406 may bond the fabric sheath of one of the conductive cable layers to the fabric sheath of one or two neighboring or adjacent conductive cable layers. In some implementations, the breakable adhesive drops may be applied to the fabric sheath in groups such that the drops are aligned in an aesthetically-pleasing manner, for example in first adhesive group 424a, and second adhesive group 424b. In this implementation, the breakable adhesive drops 406 may be utilized to keep the communication cable 400 coiled in an orderly and professional manner, either during transportation or storage, or in use. The uncoiled length of either of the first connector 420 or the second connector 422 may be adjusted as desired by having a splitting force applied to one conductive cable layer at a time to break the drop of adhesive bonding such layer to the rest of the coil.

Referring now to FIG. 5, a flowchart depicting an example method 500 for fabricating a communication cable is illustrated. At block 526, provide a first conductive cable and a second conductive cable aligned with the first conductive cable. Each of the first and second conductive cables having a fabric sheath. At block 528, deposit an array of adhesive drops along a length of the first and second conductive cables, bonding the fabric sheaths of the first and second conductive cables to one another. In some implementations, the method 500 may further include depositing the array of adhesive drops with a spacing of about 3 mm between adjacent drops. In further implementations, the method 500 may further include depositing the adhesive drops wherein each adhesive drop has a mass of about 0.020 g.

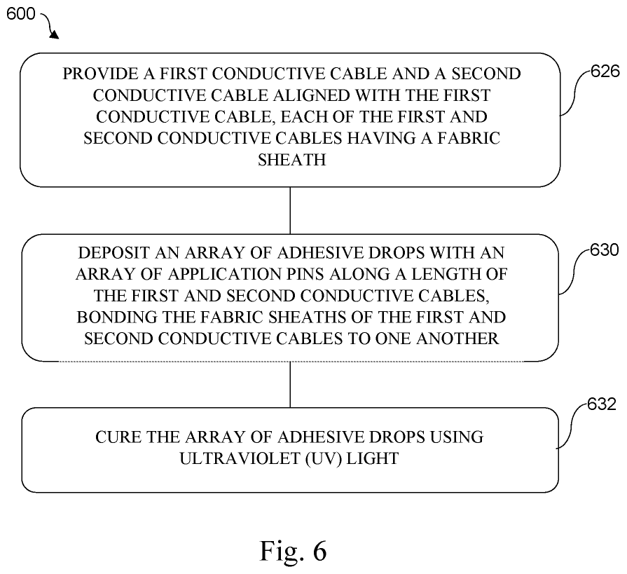

Referring now to FIG. 6, a flowchart depicting an example method 600 for fabricating a communication cable is illustrated. At block 626, provide a first conductive cable and a second conductive cable aligned with the first conductive cable. Each of the first and second conductive cables having a fabric sheath. At block 630, deposit an array of adhesive drops with an array of application pins along a length of the first and second conductive cables, bonding the fabric sheaths of the first and second conductive cables to one another. At block 632, cure the array of adhesive drops using ultraviolet (UV) light.

What is claimed is:

1. A communication cable, comprising:
a first conductive cable wrapped in a fabric sheath;
a second conductive cable wrapped in a fabric sheath; and
a breakable adhesive bonding the fabric sheath of the first conductive cable to the fabric sheath of the second conductive cable.

2. The communication cable of claim 1, wherein the breakable adhesive is to break upon a splitting force of about 0.2 Newtons (N) being applied between the first conductive cable and the second conductive cable.

3. The communication cable of claim 1, wherein the breakable adhesive comprises an array of adhesive drops disposed along a length of the first conductive cable and the second conductive cable.

4. The communication cable of claim 3, wherein the array of adhesive drops has a spacing of about 3 millimeters (mm) between adjacent adhesive drops.

5. The communication cable of claim 3, wherein each adhesive drop of the array of adhesive drops has a mass of about 0.02 grams (g) to about 0.04 g.

6. The communication cable of claim 1, wherein the breakable adhesive is to have a permeation of less than about 20% into the fabric sheath of the first conductive cable and the second conductive cable.

7. A communication cable, comprising:
a first conductive cable wrapped in a fabric sheath and having a first end and a second end, opposite the first end;
a second conductive cable wrapped in a fabric sheath and having a first end and a second end, opposite the first end;
a combined connector communicatively engaged with the first ends of the first and second conductive cables;
a first separate connector communicatively engaged with the second end of the first conductive cable;
a second separate connector communicatively engaged with the second end of the second conductive cable; and
a breakable adhesive bonding the fabric sheath of the first conductive cable to the fabric sheath of the second conductive cable.

8. The communication cable of claim 7, wherein the breakable adhesive comprises an array of adhesive drops disposed along a length of the first conductive cable and the second conductive cable in between the combined connector and the first and second separate connectors.

9. The communication cable of claim 8, wherein each adhesive drop of the array of adhesive drops is separately breakable from the other adhesive drops of the array of adhesive drops.

10. The communication cable of claim 7, further comprising a strain relief movable along the length of the first and second conductive cables.

11. A method of fabricating a communication cable, comprising:
providing a first conductive cable and a second conductive cable aligned with the first conductive cable, each of the first and second conductive cables having a fabric sheath; and
depositing an array of adhesive drops along a length of the first and second conductive cables, bonding the fabric sheaths of the first and second conductive cables to one another.

12. The method of claim 11, wherein the depositing further comprises depositing the array of adhesive drops with a spacing about 3 millimeters (mm) between adjacent adhesive drops.

13. The method of claim 11, wherein the depositing further comprises depositing the array of adhesive drops with an array of application pins.

14. The method of claim 11, wherein the depositing further comprises depositing the array of adhesive drops, wherein each adhesive drop has a mass of about 0.020 grams (g).

15. The method of claim 11, further comprising curing the array of adhesive drops using ultraviolet (UV) light.
